(19) United States
(12) Patent Application Publication
(10) Pub. No.: US 2009/0003587 A1
(43) Pub. Date: Jan. 1, 2009

(54) LINE POWERING AN AUXILIARY DEVICE

(75) Inventors: Christopher Stuart Smith, Mission Viejo, CA (US); Benedict A. Itri, Newport Beach, CA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: AKTINO, INC., Irvine, CA (US)

(21) Appl. No.: 12/140,987

(22) Filed: Jun. 17, 2008

Related U.S. Application Data
(60) Provisional application No. 60/944,742, filed on Jun. 18, 2007.

(51) Int. Cl. H04M 1/00

(52) U.S. Cl. 379/413

(57) ABSTRACT

A system for providing subscriber line power to an auxiliary device may include a primary communications device, a secondary communications device, and an auxiliary device. The primary communications device and the secondary communications device may be connected to opposite ends of at least one subscriber line. The auxiliary device may be connected to the secondary communications device. The auxiliary device may be powered by the primary communications device via the subscriber line and the secondary communications device. A power capacity metric of the at least one subscriber line may be determined. An operating power metric of the secondary communications device may be determined. A power budget may be calculated from the power capacity metric and the operating power metric. The power budget may be enforced. For example, the secondary communications device may limit power to the auxiliary device to enforce the power budget.

### CROSS REFERENCE TO RELATED CASES

This application claims the benefit of U.S. Provisional Application No. 60/944,742 filed Jun. 18, 2007, which is incorporated herein by reference in its entirety.

### BACKGROUND

Telecommunications networks may include connected communications equipment such as routers, switches, hubs, modems, and the like. Typically, communications equipment may be conveniently located in controlled environments with adequate available power. For example, communications equipment may be located in telecom central offices, data centers, telecom pedestals, wiring closets, and the like. These locations may be located in proximity to a power utility access facility, transformers, power taps, and the like. In addition, these locations may have the internal and external space for power subsystems. These locations may include Alternating Current (AC) power feeds, three-phase power feeds, Direct Current (DC) power feeds, battery backup, generator backup, Uniform Power Supplies (UPS), and the like.

However, some network topologies may require deploying telecommunications equipment in locations that may limit access to traditional power supplies and conditioning subsystems. For example, in wide-area wireless network deployments, wireless access points may be located on telecom poles, street lights, traffic signal structures, the external faces of buildings, and the like. In order to provide uniform coverage in such wireless networks, the location of each wireless access point may be influenced more by physical network coverage considerations than by the proximity to traditional power sources.

Network equipment in such locations may still require backhaul connectivity to a network such as an access network, private intranet, the Internet, and the like. Such backhaul connectivity may be provided by a communications link. For example, a subscriber line communications device may provide the backhaul communications link to the access point. The subscriber line communications device may use the local loop for physical connectivity.

Some subscriber line communications devices may “self-power” by drawing operating power from the subscriber lines themselves. Characteristics of the subscriber lines such as length, gauge, conductivity, number of pairs and the like may limit the amount of power available to a subscriber line device. In such a power-limited environment, increases in power-draw from the self-powered device in relation to the amount of power available may affect the stability of the system.

When changing operating states, many devices exhibit an initialization stage before entering steady-state operation. The initialization stage may include the first few seconds of operation after having been powered on, after leaving a stand-by mode, after a change in a mode of operation, or the like. Typically, the device may draw more power in the initialization stage than in steady-state operation. For example, the device may include motors and/or other mechanical devices such as fans and disk drives that may require extra power to initially spin up to operating speed. The device may include electronic components and/or subsystems such as digital chips and capacitors that may require extra power to reset and to begin to operate.

Such sudden high-power-draw periods may overtax the system's power supply and/or may exceed safety and/or regulatory limits associated with subscriber lines. Thus, there is a need to safely manage and/or provide subscriber line power to a communications device.

### SUMMARY

A system for providing subscriber line power to an auxiliary device may include a primary communications device, a secondary communications device, and an auxiliary device. The primary communications device may be connected to a first end of one or multiple subscriber lines. The secondary communications device may be connected to a second end of one or multiple subscriber lines. The auxiliary device may be connected to the secondary communications device. The auxiliary device may be powered by the primary communications device via the subscriber line or lines and the secondary communications device. The auxiliary device may be in communication with the primary communications device via the one or multiple subscriber lines and the secondary communications device.

A power capacity metric from the one or more subscriber lines may be determined. An operating power metric of the secondary communications device may be determined. A power budget for the auxiliary device may be calculated from the power capacity metric and the operating power metric. The power budget may be enforced. For example, the secondary communications device may limit power to the auxiliary device to enforce the power budget.

Additional features and advantages of the invention will be made apparent from the following detailed description of illustrative embodiments that proceeds with reference to the accompanying drawings.

### BRIEF DESCRIPTION OF THE DRAWINGS

FIG. 1 is a block diagram depicting an example operating environment for providing subscriber line power to an auxiliary device.

FIG. 2 is a block diagram depicting an example system for providing subscriber line power to an auxiliary device.

FIG. 3 is a flow diagram depicting an example method for providing subscriber line power to an auxiliary device.

FIG. 4 is a flow diagram depicting an example method for enforcing a power budget.

FIGS. 5A-5C depict a isometric view of an example enclosure, with exploded components, with assembled components with the enclosure door open, and with the enclosure door closed, respectively.

FIG. 6 depicts a circuit diagram of an example device for providing subscriber line power to an auxiliary device.

FIG. 7 is a flow diagram depicting an example method for enforcing a power budget.

FIG. 8 is a block diagram depicting an example system for providing subscriber line power to an auxiliary device.

FIG. 9 depicts a circuit diagram of an example device for providing subscriber line power to an auxiliary device.

### DETAILED DESCRIPTION

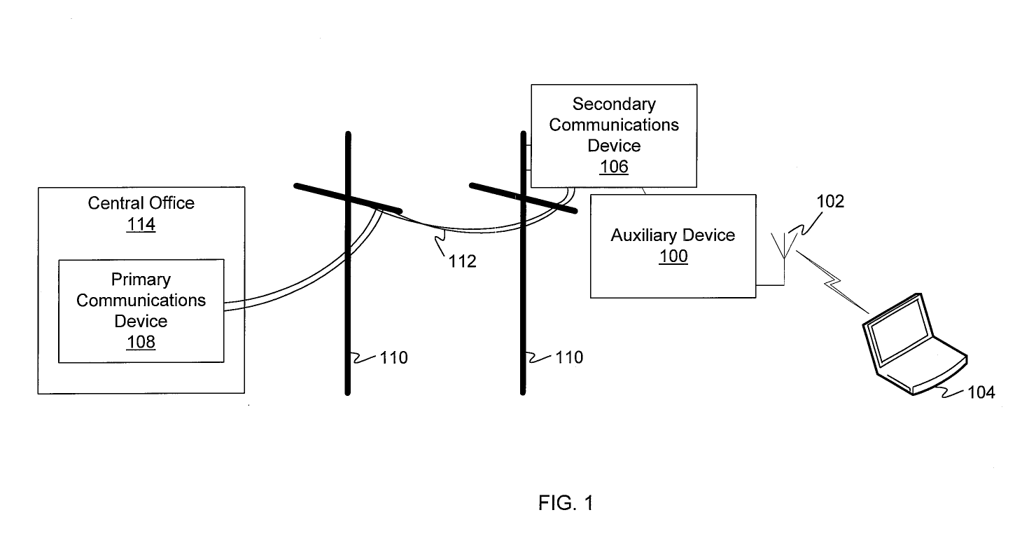

FIG. 1 is a block diagram depicting an example operating environment for providing subscriber line power to an auxiliary device 100. The example operating environment may include a wireless network deployment. The wireless network may include an auxiliary device 100 with an antenna 102. The auxiliary device 100 may provide a wireless link to a wireless device 104. The wireless link may include a wireless network protocol. For example, the wireless network protocol may be WiFi, WiMax, 802.11a/b/g/n, Bluetooth, and the like. The auxiliary device 100 may be a wireless access point, wireless router, or the like.

The auxiliary device 100 may be in communication with a secondary communications device 106. The secondary communications device 106 may provide backhaul connectivity to a primary communications device 108. The secondary communications device 106 and the auxiliary device 100 may be deployed at a distance from the primary communications device 108. For example, the secondary communications device and the auxiliary device may be mounted to a telephone pole 110, a light post, the external face of a building, a traffic signal structure, a billboard, or the like.

The secondary communications device 106 and the primary communications device 108 may be connected via one or more subscriber lines 112. For example, the secondary communications device 106 may be at a first end of the one or more subscriber lines 112, and the primary communications device 108 may be at an opposite end of the one or more subscriber lines 112. The one or more subscriber lines 112 may be traditional telephony subscriber lines, data subscriber lines, such as digital subscriber line (DSL), or the like. For example, each of the one or more subscriber lines 112 may be a twisted pair of wires. The one or more subscriber lines 112 may originate at a central office 114, controlled environment vault, telecommunications hut, walk in cabinet, pedestal, electronic equipment enclosure remote terminal, or the like. The central office 114 may house the primary communications device 108. For example, the central office 114 and the subscriber lines may be part of the public switched telephone network (PSTN).

The primary communication device 108 may provide power to the secondary communications device 106 via the one or more subscriber lines 112. For example, the primary communications device 108 may apply a voltage to each twisted pair. The secondary communications device 106 may draw that voltage from each twisted pair.

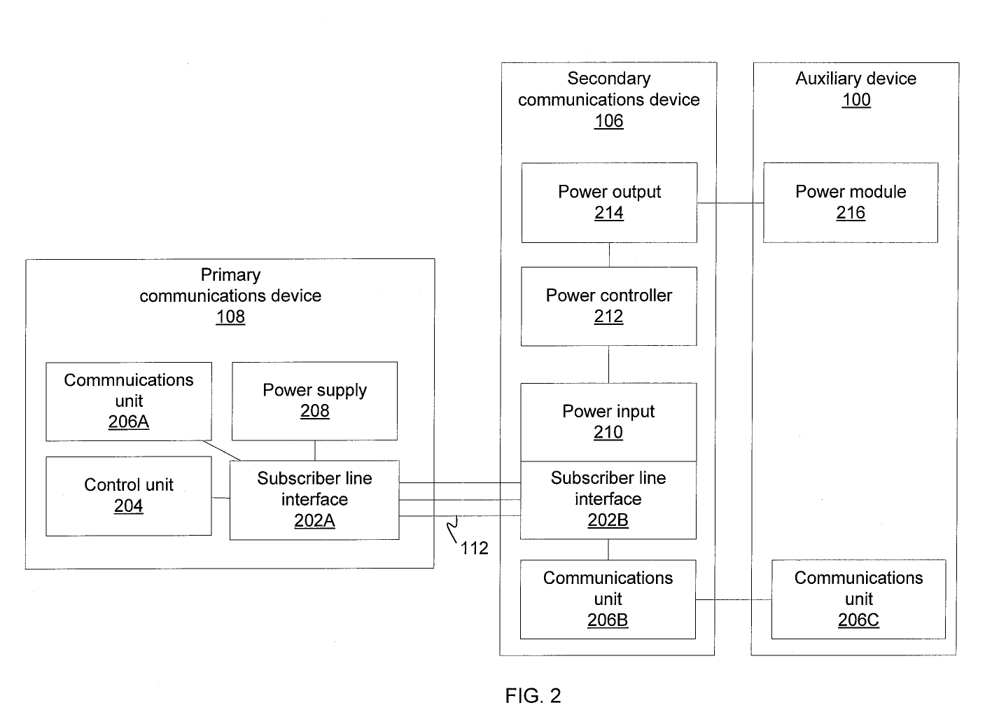

FIG. 2 is a block diagram depicting an example system for providing subscriber line power to the auxiliary device 100. The example system may include the primary communications device 108, the secondary communications device 106, and the auxiliary device 100.

The primary communications device 108 may include a subscriber line interface 202A in communication with a control unit 204 and a communications unit 206A. The subscriber line interface 202A may be connected to a power supply 208.

The subscriber line interface 202A may be any system, subsystem, and/or component suitable for monitoring, controlling, and/or enabling communication and/or power delivery via one or more subscriber lines 112. For example, the subscriber line interface 202A may terminate one or more twisted pair wires.

The power supply 208 maybe any system, subsystem, and/or component suitable for providing power. For example, the power supply 208 may be an AC-to-DC converter, DC-to-DC converter, uninterruptable power supply (UPS), battery backup subsystem, or the like. The power supply 208 may provide power to the subscriber line interface 202A. The subscriber line interface 202A may apply this power to the one or more subscriber lines 112. For example, the subscriber line interface 202A may apply between about 4 W to about 70 W of total power available to the subscriber lines depending on parameters including the number of available twisted pairs, their gauge, their length, and the like. For example, the subscriber line interface 202A may apply between about 50 V and about 185V on each twisted pair of the one or more subscriber lines 112.

The communications unit 206A may be any system, subsystem, and/or component suitable for transmitting and/or receiving data via the subscriber line interface 202A. The communications unit 206A within the primary communications device 108 may provide data communications with a complementary communications unit 206B within the secondary communications device 106. For example, the communications unit 206A may include a digital subscriber line (DSL) chipset. The communications unit 206A may provide high speed digital data connectivity using, but not limited to, any of DSL transmission standards such as High bit rate Digital Subscriber Line (HDSL), Integrated Services Digital Network (ISDN), Asymmetric Digital Subscriber Line (ADSL), Very High Speed Digital Subscriber Line (VDSL), and/or their variations. The communications unit 206A may be responsible for modulating/demodulating the communication signals, and providing all necessary functions required to achieve reliable data transmission like data framing, timing recovery, error correction coding and other well known data communications functions.

The control unit 204 maybe any system, subsystem, and/or component suitable for monitoring, controlling, and/or managing the power delivery and power consumption of the system. The control unit 204 may include hardware and/or software. For example, the control unit 204 may include a microcontroller, microprocessor, or the like and/or may be designed using discrete components.

The control unit 204 may determine a power capacity metric related to the one or more subscriber lines 112. The power capacity metric may be associated with the electrical and/or physical characteristics of the one or more subscriber lines 112. For example, the power capacity metric may be associated with the length, gauge, conductivity, and the like of the one or more subscriber lines 112.

The power capacity metric may represent a maximum power applicable to the one or more subscriber lines 112. The power capacity metric may be limited by the total output power capability of the primary communications 108 device power supply 208. The power capacity metric may represent the maximum power that may be safely and/or legally applied to the one or more subscriber lines 112. The power capacity metric may be set at about 100 Watts per subscriber line pair, as specified by Telcordia GR-1089, Electromagnetic Compatibility and Electrical Safety—Generic Criteria for Network Telecommunications Equipment. A single 100 Watt supply may be used, and/or a separate power supply for each pair both on the primary and secondary communication devices may be used. The power capacity metric may be set according current limit regulation defined in electrical standards, such as UL-60950 Part 1 and UL-60950 Part 21.

The control unit 204 may determine the power capacity metric by applying a test current to each twisted pair and measuring the response. For example, the control unit 204 may apply a known current and measure the voltage response to automatically determine the line resistance for each subscriber line powering pair 112.

In an embodiment, the control unit 204 may determine the power capacity metric from stored data. For example, the control unit 204 may retrieve data associated with the one or more subscriber lines 112 and calculate the power capacity metric. For example, store data may include manually entered data that represents the power capacity of the one or more subscriber lines 112. The stored data may include characteristics for each subscriber line, and the control unit 204 may calculate the power capacity metric from those characteristics.

The control unit 204 may determine a power consumption metric of only the secondary communications device 106 by initially disabling power to the auxiliary device 100. The control unit 204 may determine the power consumption metric of the secondary communications device 106 by directing the secondary communications device 106 to power on. The control unit 204 may measure the power provided to the secondary communications device 106. For example, the control unit 204 may measure the operating power consumed by the secondary communications device 106 as well as power losses on the subscriber line. For example, the control unit 204 may receive data from the secondary communications device 106 related to power consumption, and the control unit may compare this data to a determination of the amount of power available from the primary communications device 108. The control unit 204 may calculate the power consumption metric of the secondary communications device 106. For example, the control unit 204 may determine the power consumption metric of the secondary communications device 106 to be a fixed percentage of the measured operating power consumption. In an embodiment, the control unit 204 may determine the power consumption metric of the secondary communications device 106 by retrieving stored data associated with the secondary communications device 106. The stored data may include the expected and/or calculated power consumption of the secondary communications device 106. In an embodiment, the control unit 204 may determine the power consumption metric of the secondary communications device 106 by receiving data from the secondary communications device. For example, the secondary communications device 106 may provide a self test. During the self test, the secondary communications device 106 may measure its power consumption and communicate this to the control unit 204 via the one or more subscriber lines 112.

The control unit 204 may calculate a power consumption budget according to at least the power capacity metric, the power consumption metric of the second communications device and/or the minimum number of operating subscriber lines. In an embodiment, the control unit 204 may calculate the power consumption budget as the difference between the power capacity metric and the power consumption metric of the second communications device plus the power dissipated on the subscriber lines. The power consumption budget may represent a maximum power that may be consumed by the auxiliary device 100. The power consumption budget may be a fixed metric and/or a function of time. For example, the power consumption budget may include one or more power levels associated with duration of time or the operating state of the auxiliary device 100. To illustrate a power consumption budget that is a function of time, the power consumption budget a may allow power consumption greater than 10 W and less than 50 W for no more than 100 ms.

The control unit 204 may communicate the power consumption budget to the secondary communications device 106. For example, the control unit 204 may communicate the power consumption budget via the communications unit 206A. The control unit 204 may communicate the power consumption budget as a fixed metric and/or as a function of the operating state of the secondary communications device 106. Control unit 204 may communicate the power budget upon the power up and initialization of the secondary communications device 106. The control unit 204 may update the power budget while the secondary communications device 106 is in operation. The control unit 204 may communicate an update of the power budget to the secondary dedications device.

The secondary communications device 106 may include a subscriber line interface 202B in connection with a power input 210, a power controller 212, a power output 214, and a communications unit 206B. The subscriber line interface 202B may be any system, subsystem, and/or component suitable for terminating the one or more subscriber lines 112. The subscriber line interface 202B may receive subscriber line power from the primary communications device 108. The subscriber line interface 202B may connect to the communications unit 206B. The communications unit 206B of the secondary communications device 106 may be in communication with a corresponding communications unit 206A of the primary communications device 108. The communications unit 206B of the secondary communications device 106 may be in communication with the communications unit 206C of the auxiliary device 100. For example, the communications unit 206B of the secondary communications device 106 may communicate via Ethernet to the communications unit 206C of the auxiliary device 100. The system may enable communication between the communications unit 206A of the primary communications device 108 and the communications unit 206C of the auxiliary device 100.

The power input 210 may receive subscriber line power from the subscriber line interface 202B. The secondary communications device 106 may power itself with subscriber line power received via the subscriber line interface 202B from the primary communications device 108. The power output 214 may provide power to the auxiliary device 100. The power output 214 may be connected to a power module 216 of the auxiliary device 100. The power controller 212 may be in communication with the power input 210 and the power output 214.

The power controller 212 may determine the power budget available for the auxiliary device 100. The power controller 212 may determine the power budget available for the auxiliary device 100 by receiving data indicative of the power budget available from the primary communications device 108. The power controller 212 may determine the power budget available for the auxiliary device 100 by calculating the power consumption of the secondary communications device 106 and comparing it to the power capacity metric of the one or more subscriber lines 112 and the operating state of the secondary communications device 106. The power controller 212 may receive the power capacity metric of the one or more subscriber lines 112 from the primary dedications device. The power controller 212 may receive the power capacity metric of the one or more subscriber lines 112 from the subscriber line interface 202B of the secondary communications device 106. For example, the subscriber line interface 202B of the secondary communications device 106 may test the one or more subscriber lines 112 to determine the number of subscriber lines currently providing power.

The power controller 212 may determine a power consumption metric of the auxiliary device 100. The power controller 212 may determine the power consumption metric of the auxiliary device 100 by measuring the amount of power drawn by the auxiliary device 100 while the auxiliary device 100 is in operation. The power controller 212 may determine the power consumption metric of the auxiliary device 100 by retrieving stored data indicative of the power consumption metric. The stored data indicative of the power consumption metric may be manually entered and/or previously stored based on the design specifications and/or testing of the auxiliary device 100. The power consumption metric may be measured based on a continual monitoring and testing of the auxiliary device 100.

The power controller 212 may limit the power provided by the power input 210 to the power output 214 according to the power budget available and the power consumption metric of the auxiliary device 100. The power controller 212 may monitor the power drawn by the auxiliary device 100 to update the power consumption metric of the auxiliary device 100. The power controller 212 may monitor the power consumption metric of the auxiliary device 100, and the power controller 212 may discontinue power from the power input 210 to the power output 214, and thus, to the auxiliary device 100, when the power consumption metric exceeds the power budget available. The power controller 212 may communicate a maximum power level to the auxiliary device 100 via the communications unit 206B, and the auxiliary device 100 may adjust its operating power level according to the maximum power level communicated by the power controller 212. The power controller 212 may measure the auxiliary device's response to receiving the maximum power level, to ensure that the maximum power available is not exceeded and this enforcing the power consumption budget. The auxiliary device 100 may report information about its power status back to the power controller 212.

To illustrate, the power consumption budget for the auxiliary device 100 may be about 10 W. The power controller 212 may continuously monitor the power drawn by the auxiliary device 100 and record the power consumption metric of the auxiliary device 100. The power controller 212 may compare the power consumption metric of the auxiliary device 100 to the power budget available for the auxiliary device 100. If the power consumption metric of the auxiliary device 100 exceeds the power budget for the auxiliary device 100, the power controller 212 may limit the amount of power being provided to the auxiliary device 100. For example, the power controller 212 may limit the total power provided to the auxiliary device 100 to 10 W.

In an embodiment, more than one auxiliary device may receive power from the secondary communications device 106. The power controller 212 may determine a power consumption budget for each auxiliary device 100. The power controller 212 may determine a power consumption metric for each auxiliary device 100. The power controller 212 may limit the power provided to each individual auxiliary device 100 according to their respective power budget available and their respective power consumption metric.

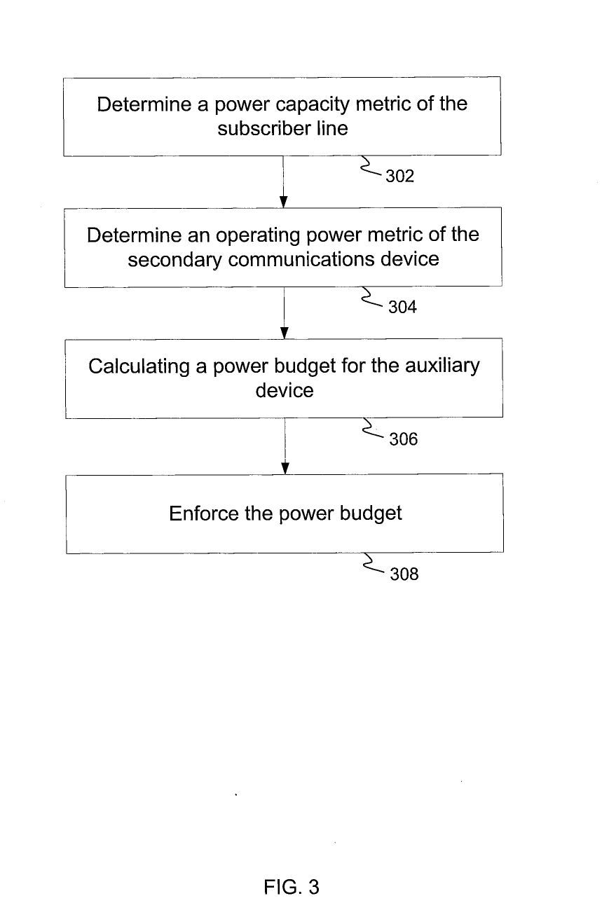

FIG. 3 is a flow diagram depicting an example method for providing subscriber line power to an auxiliary device 100. At 302, a power capacity metric of the subscriber line may be determined. For example, the primary device may determine the power capacity metric of the subscriber line. The power capacity metric of the subscriber line may be determined by measuring a test signal placed on the subscriber line. For example, the test signal may have a known test current or test voltage The primary device may measure a voltage/current associated with the known test current/voltage to determine the subscriber line's conductivity/resistance. The power capacity metric of the subscriber line may be determined, retrievably stored, and made available to the primary communications device 108 and/or secondary communications device 106.

At 304, an operating power metric of the secondary communications device 106 may be determined. The primary communications device 108 may direct that the secondary communications device 106 to power on and that the auxiliary device remain powered off. The primary communications device 108 may measure the power draw of the secondary communications device 106. The primary communications device 108 can then calculate the power consumption of the secondary communication device by subtracting the power dissipated in the subscriber lines as measured in 304 and may store the measurement as the operating power metric of the secondary communications device 106. In an embodiment, the secondary communications device 106 may measure its power consumption and communicate this to the primary communications device 108.

At 306, an available power budget for the auxiliary device 100 may be calculated. The primary communications device 108 may calculate the available power budget for the auxiliary device by summing the power capacity metric of the minimum number of subscriber lines available for powering and the operating power metric of the secondary communications device 106. The power budget for the auxiliary device 100 may be calculated as a percentage of the difference between the power capacity metric of the subscriber line and the operating power metric of the secondary communications device 106. For example, the power budget may be 80% of the difference between the power capacity metric of the subscriber line and the operating power metric of the secondary communications device 106.

At 308, the available power budget may be enforced. In an embodiment, the power budget may be enforced by the secondary communications device 106. The available power budget may be enforced by limiting the power provided to the auxiliary device 100. The available power budget may also, or alternatively, be enforced by reducing power consumption of the secondary communications device 106 by powering down non-essential functions, freeing power for the auxiliary device 100. For example, the power budget may be enforced by temporarily disabling one or more subsystems of the secondary communications device 106.

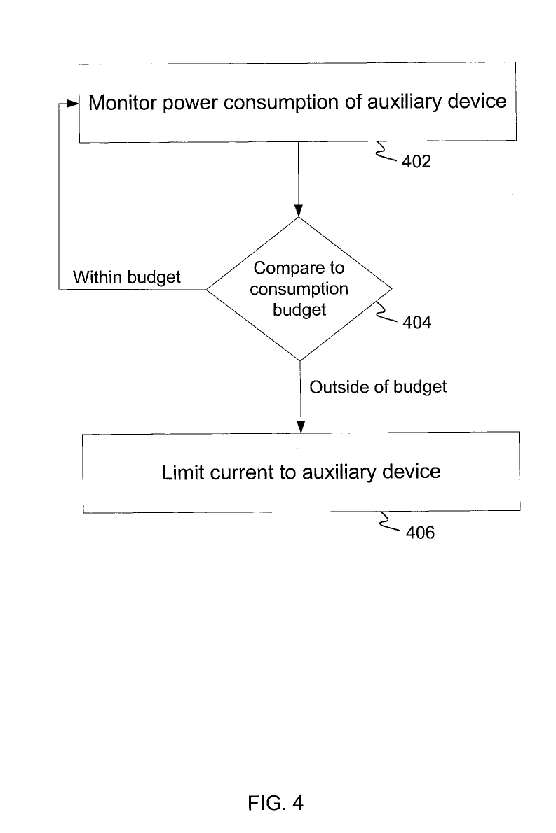

FIG. 4 is a flow diagram depicting an example method for enforcing a power budget. At 402, the secondary communications device 106 may monitor the auxiliary device 100. At 404, the power consumed by the auxiliary device 100 may be compared to the power budget available.

When the power consumption of the auxiliary device 100 is below the power budget available, the secondary communications device 106 may continue to monitor the power consumption of the auxiliary device 100. When the power consumed by the auxiliary device 100 exceeds the power budget available, the secondary communications device 106, at 406, may limit the power it provides to the auxiliary device 100. The secondary communications device 106 may enforce the power budget. For example, the secondary communications device 106 may disable the auxiliary device 100 when the power consumed by the auxiliary device 100 exceeds the power budget available.

The power budget may be enforced by a time sensitive function. For example, the secondary communications device 106 may disable the auxiliary device 100 when the power consumed by the auxiliary device 100 exceeds the power budget available for a fixed length of time. For example, the fixed length of time may be about 100 ms. For example, the length of time may be determined by the transient response of the auxiliary device.

The power budget may be enforced by directing the auxiliary device 100 to operate in a reduced power consuming mode. For example, the secondary communications device 106 may direct the auxiliary device 100 to enter a low power mode. For example, the secondary communications device 106 may communicate the power budget available to the auxiliary device, such that the auxiliary device may operate within the power budget.

The power budget may be enforced by adjusting the power drawn by the secondary communications device 106. The secondary communications device 106 may enter an operating mode that consumes less power, thus, freeing additional power for use by the auxiliary device 100. The secondary communications device 106 may temporarily disable one or more subsystems. The secondary communications device 106 may select the one or more subsystems to disable based on the extent to which the auxiliary device 100 exceeds the power budget available.

The power budget may be enforced by limiting the power provided to the auxiliary device. For example, the secondary communications device 106 may limit the current flow to the auxiliary device 100 at a given voltage. The secondary communications device 106 may include a current limiting circuit that defines a maximum current limit available to the auxiliary device consistent with the power budget available.

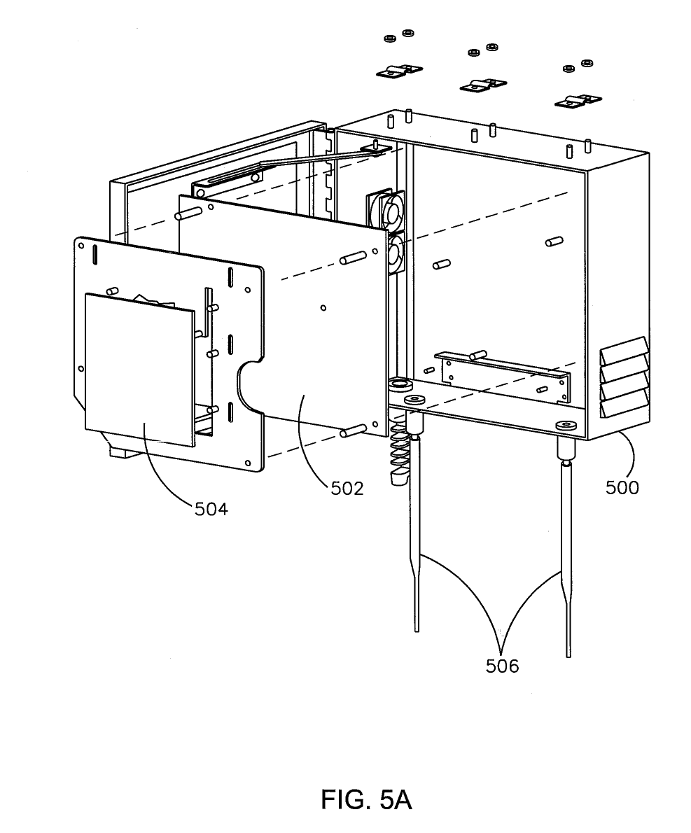

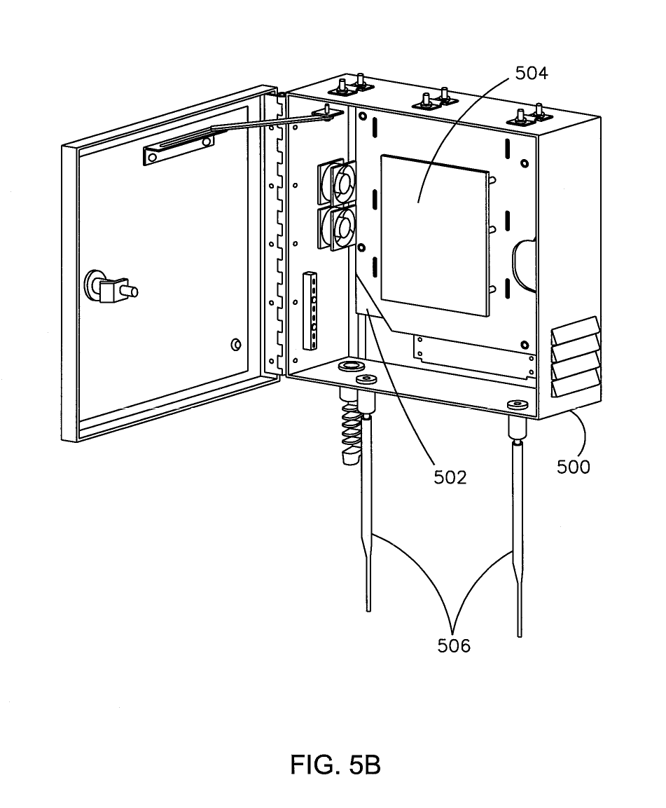

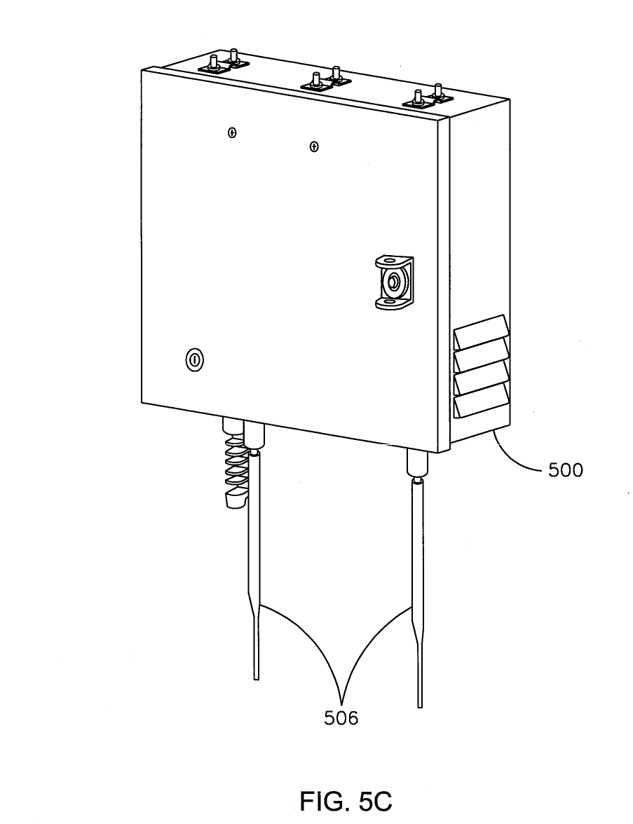

FIGS. 5A-5C depict a isometric view of an example enclosure 500, with exploded components, with assembled components with the enclosure 500 door open, and with the enclosure 500 door closed, respectively. The enclosure 500 may include the secondary communications device 106 and the auxiliary device 100. The secondary communications device 106 may be implemented in a first circuit board 502. The auxiliary device 100 may be implemented in a daughter circuit board 504. The daughter circuit board 504 may be electrically connected to the first circuit board 502, such that the daughter circuit board 504 may receive power from the first circuit board 502 and such that the daughter circuit board 504 and the first circuit board 502 makes exchange data communications.

The enclosure 500 may include one or more antennas. The one or more antennas may be connected to the daughter circuit board 504. The enclosure 500 may include a door for operations access. The enclosure 500 may be suitable for external mounting. For example, the enclosure 500 may be suitable for mounting to telecom poles, street lights, aerial cable strands, traffic signal structures, the external faces of buildings, and the like.

The auxiliary device 100 may comprise a wireless access point. The auxiliary device 100 may provide wireless data indications via the one or more antennas. The auxiliary device 100 may be powered by the secondary communications 106 device. The secondary communications device 106 may provide backhaul conductivity to a data network via the primary communications device 108. The secondary communications device 106 may be powered by the primary communications device 108. The auxiliary device 100 may be powered by the secondary communications device 106. Thus, the enclosure 500 may be mounted, and the wireless access may be provided, in an area without convenient access to traditional power supplies.

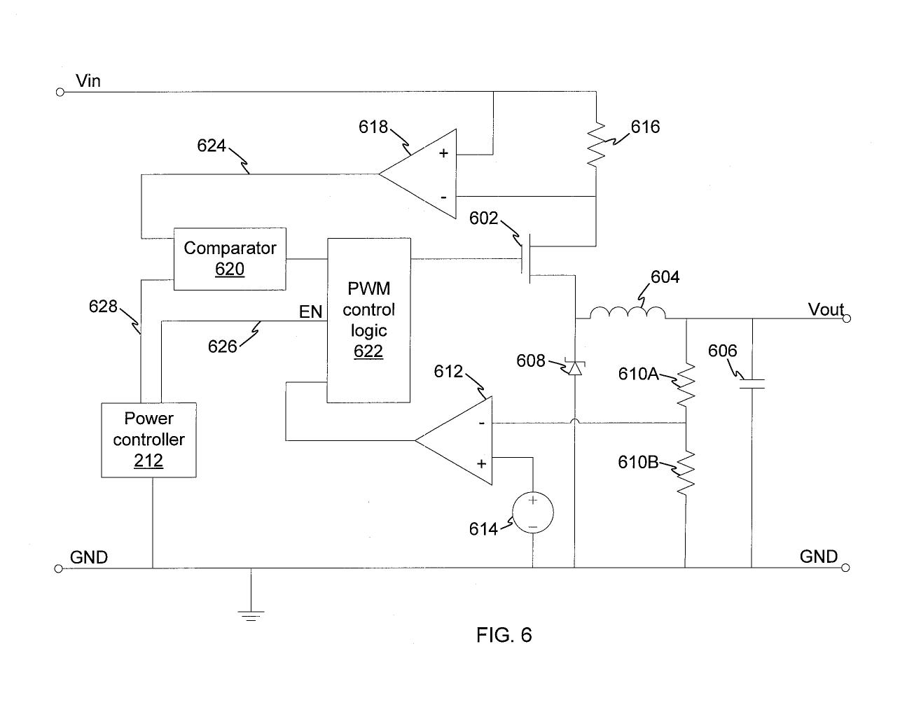

FIG. 6 depicts a circuit diagram of an example device for providing subscriber line power to an auxiliary device. The circuit depicted may be used by secondary communications device 106 to enforce the power budget of the auxiliary device 100. The Vin node may receive power from the secondary communications device 106, and the Vout node may provide power to the auxiliary device 100. Current may flow from the Vin node across a current sense resistor 616, across the FET 602, into the output-stage circuit, and to the Vout node. The auxiliary device may receive power from the Vout node. As shown in FIG. 6, the output-stage circuit may include a schottky diode 608 connected to an inductor 604, feedback resistors 610a-b, and an output capacitor 606. The feedback resistors 610a-b may be in series with one another and in parallel with the output capacitor. The output-stage may provide feedback and/or power signal conditioning.

The output current of the secondary communications device 106 may be measured and limited according to a reference. For example, current draw across the current sense resistor 616 may be measured and amplified by the current sense amplifier 618. The output of the current sense amplifier 618 may be a current sense signal 624. The current sense signal 624 may be inputted to a comparator 620. A power controller 212 may generate a programmable current limit signal 628. The current limit signal 628 may be inputted to the comparator 620. The comparator 620 may compare the current sense signal 624 with the current limit signal 628. The output of the comparator may be inputted to a pulse width modulated control logic circuit 622. The pulse width modulated control logic circuit 622 may control the on time of the FET 602 accordingly to effectively limit the output power available to the auxiliary device to the power budget available.

When the FET 602 is closed, current may flow from the Vin node to the Vout node. When this current exceeds a limit, the pulse width modulated control logic circuit 622 may open the FET 602 and impede the current flow from the Vin node to the Vout node. The pulse width modulated control logic circuit 622 may open the FET 602 at regular intervals to control the current flow. The pulse width modulated control logic circuit 622 may receive an enable signal 626 from the power controller 212. The enable signal 626 may indicate to the pulse width modulated control logic circuit 622 an on or off state.

The pulse width modulated control logic circuit 622 may receive a feedback signal 630 from an error amplifier 612. The error amplifier may receive a reference voltage 614. The error amplifier may receive a feedback voltage measured between the feedback resistors 610a-b. The error amplifier may communicate the difference between the reference voltage 614 and the feedback voltage in the feedback signal 630. The pulse width modulated control logic circuit 622 may adjust the open time of the FET 602 according to corrections associated with the feedback signal 630.

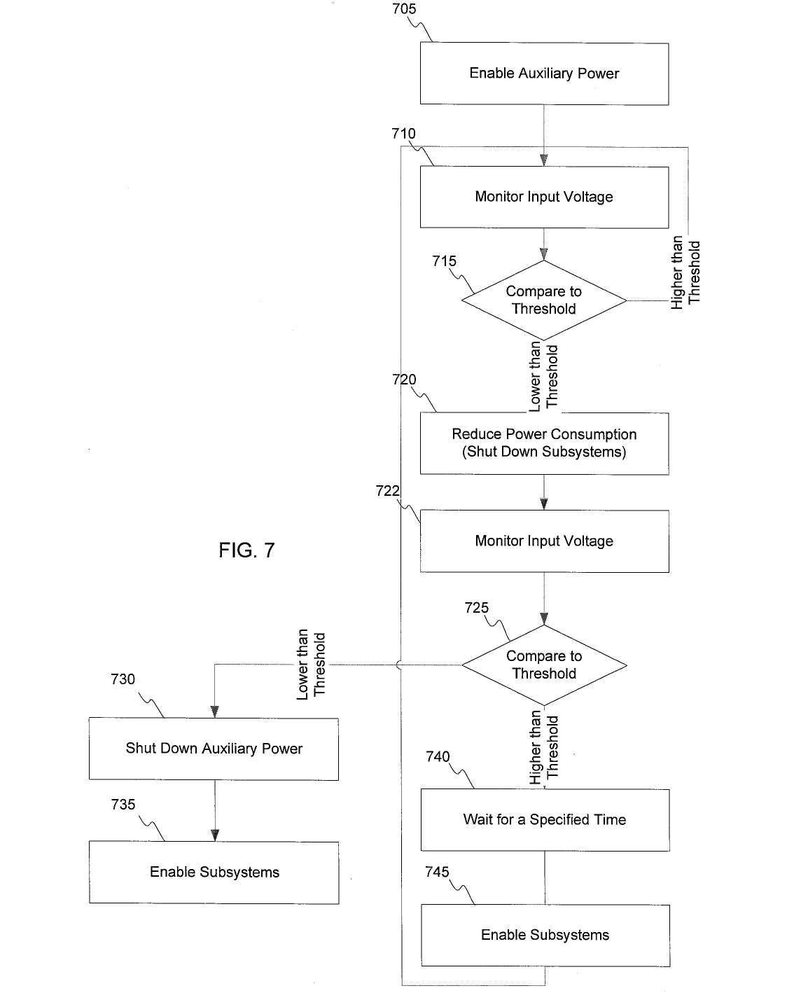

FIG. 7 is a flow diagram depicting an example method for enforcing a power budget. The increase of the current drawn via the copper lines from the primary communications device 108 may result in a drop in the voltage at the input of the secondary communications device 106. If the voltage drop is significant, it may endanger the proper operation of the secondary communications device 106. In an embodiment, the input voltage may be used as a measure of the health of the overall line powering system.

The power management system of the secondary communications device 106 may temporarily reduce the secondary device's power consumption while enabling power to the auxiliary device 100. The power management system of the secondary communications device 106 may temporarily reduce the secondary device's power consumption in response to a drop in input voltage to the secondary communications device 106. The secondary communications device 106 may temporarily disable one or more subsystems to reduce the power consumed by the secondary communications device 106, freeing that power to be consumed by the auxiliary device 100. The secondary communications device 106 may turn off one or more fan motors for several seconds without affecting the device's other operations. The secondary communications device 106 may temporarily disable components such as disk drive motors, auxiliary and/or redundant communication links, or the like.

The power management system of the secondary communications device 106 may temporarily reduce the secondary device's power consumption to accommodate power surges associated with an operation of the auxiliary device 100. The auxiliary device 100 may exhibit a power surge when initially powering on. The auxiliary device 100 may exhibit a power surge when changing a mode of operation. For example, changing a mode of operation in the auxiliary device 100 may include powering a subsystem which may drive a temporary power surge. Once the power surge is complete, the auxiliary device 100 may resume power consumption at a stable level.

As shown in FIG. 7, the power management system may accommodate power surges associated with the auxiliary device 100 (such as a power surge that occurs when the auxiliary device is initially powered on). At 705, the system enables power to the auxiliary device.

At 710, the input voltage level may monitored. The input voltage level may be the input voltage level measured at the subscriber line interface 202B of the secondary communications device. The input voltage level may be indicative of the overall power draw (i.e., that of the secondary communications device and the auxiliary device). Alternatively, current draw or any other metric associated with the power consumption health of the system may be monitored.

At 715, the monitored input voltage may be compared to a threshold value. The threshold value may be set to a voltage value associated with a boundary of normal operating power draw. While the monitored input voltage is above the threshold value, the system continues operation and/or continues to monitor the input voltage. When the input voltage drops below the threshold value, the system may respond. The input voltage drop may be associated with an excessive current draw by the secondary communications device and/or the auxiliary device.

At 720, the system may disable one or more subsystems. Disabling one or more subsystems may reduce power consumption. The input voltage may be monitored again, at 722. The newly measured input voltage may be compared to the threshold, at 725, to determine if disabling the one or more subsystems effectively reduced power consumption. In an embodiment, the one or more subsystems may be disabled at once. In an embodiment, the one or more subsystems may be individually disabled, with the system measuring the input voltage's response each time.

If the newly measured input voltage, at 722, is above the threshold, then disabling the one or more subsystems may have been effective at reducing the power consumption. At 740, the system may wait a period of time. For example, the system may wait a predetermined period of time. For example, the system may wait a period of time determined by the difference between the various input voltage measurements and the threshold. For example, if the difference between the input voltage measurement and threshold is great, the time period may be longer than if the difference between the input voltage measurement and the threshold is small. At 745, the one or more subsystems that were temporarily disabled may be enabled. The secondary communications device 106 may resume full operations, during which the system may enter a steady state loop of repeated monitoring of the input voltage against the threshold.

If the newly measured input voltage, at 722, is below the threshold, then disabling the one or more subsystems may not have been effective at reducing power consumption. At 730, the system may disable the auxiliary device 100. The system may signal to the auxiliary device to shutdown. The system may discontinue powering the auxiliary device 100.

At 735, power may be applied back to the temporarily disabled subsystems. The disabled features of the secondary communications device 106 may be restored. In this case, the application of power to the auxiliary device 100 may be considered to have exception condition. For example, the device may be operating in an environment with insufficient subscriber lines, inadequate subscriber line wire gauge, and/or with an excessive distance between the primary and secondary communication devices. For example, the device may have failed. The system may signal an alarm for a technician to inspect, reset, and/or repair the device in the exception condition. The technician may reconfigure the system to allow adequate power to reach the secondary communication device 106 for the auxiliary device 100 to function correctly.

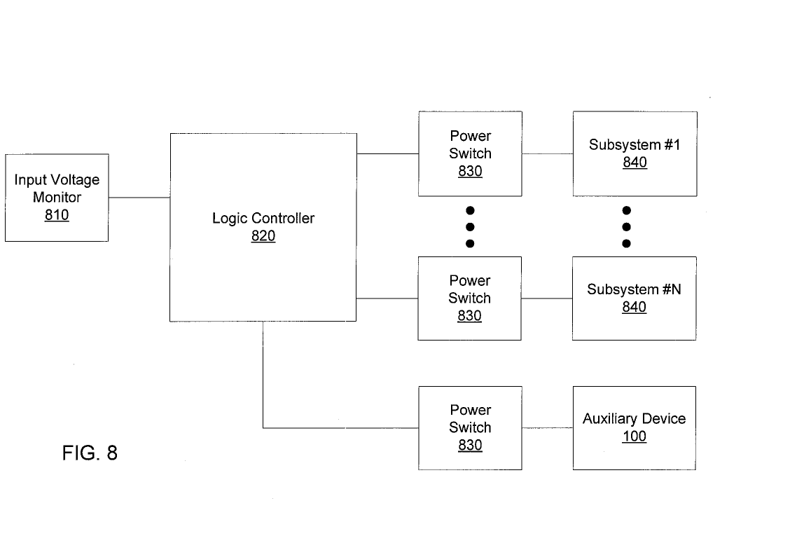

FIG. 8 is a block diagram depicting an example system for providing subscriber line power to an auxiliary device. The system may include an input voltage monitor 810, a logic controller 820, and one or more power switches 830. The logic controller 820 may be connected to the input voltage monitor 810 and the one or more power switches 830. One or more subsystems 840 may each be connected to a respective power switch 830. The auxiliary device 100 may be connected to a power switch 830. The input voltage monitor 810, logic controller 820, and one or more power switches 830 may be implemented in various portions of the secondary communications device 106. For example, the input voltage monitor 810 may be implemented in the subscriber line interface 202B and/or the power input. For example, the logic controller may be implemented in the power controller 212. For example, the one or more power switches may be implemented in the power output 214.

The input voltage monitor 810 may measure the input voltage at the one or more subscriber lines 112 that power the secondary communications device 106 and/or the auxiliary device 100. The input voltage monitor 810 may send a signal indicative of the input voltage level to the logic controller 820. The input voltage monitor 810 and the logic controller 820 may be an analog system, a digital system, or a combination. For example, the input voltage monitor 810 may provide raw analog and/or digitized signals indicative of the voltage level to the logic controller 820.

The logic controller 820 may be any system, subsystem, and/or component suitable for processing data. For example, the logic controller may include digital logic gates, a programmable logic device, a field programmable gate array, a microcontroller, a microprocessor, or the like. The logic controller 820 may perform comparisons of the received signals against a given threshold. For example, the logic controller 820 may implement corresponding measurement comparison, timing, and switch activation functions shown in FIG. 7. The logic controller 820 may enable or disable one or more subsystems and/or the auxiliary device by operation of the one or more power switches 830. In an embodiment, the logic controller 820 may receive an indication from input voltage monitor 810 based on whether the input voltage is above or below a threshold value. The logic controller 820 may implement timing and switch activation functions based on the indication from the input voltage monitor 810. For example, the timing function may include determining a time period between switch activation and the measurement comparison.

The one or more power switches 830 may be individually controllable by the logic controller 820. This architecture enables the logic controller 820 to selectively enable and disable one or more subsystems according to the received voltage level and its comparison to a threshold voltage value.

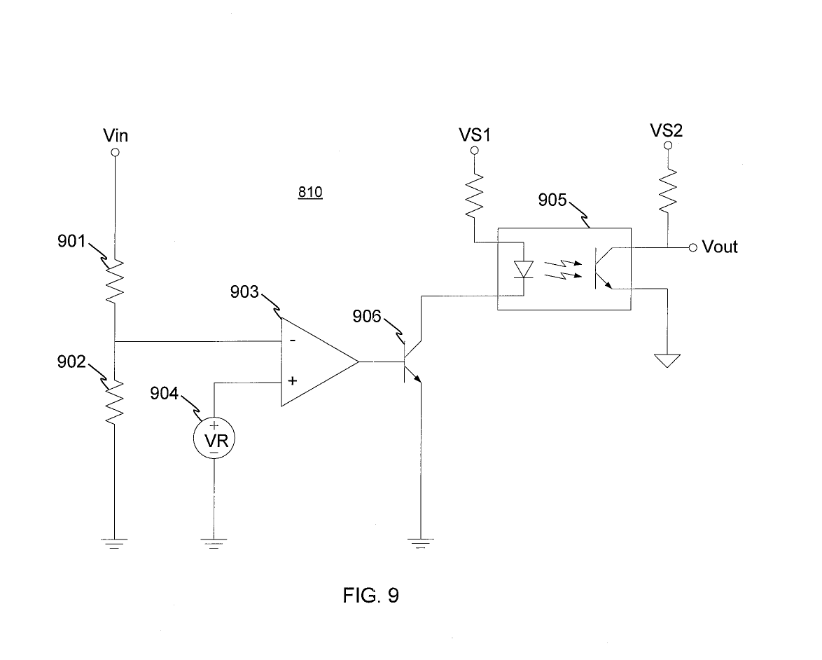

FIG. 9 depicts a circuit diagram of an example input voltage monitor 810. The input voltage may be measured at the Vin node. The input voltage may be reduced by the potential divider across resistors 901, 902. The reduced voltage, present between the resistors 901, 902, may be proportional to the voltage present at Vin. The reduced voltage may be presented to the inverting input of a comparator 903. The non-inverting input of the comparator 903 may be supplied by a reference voltage source 904.

The reference voltage source 904 may be a threshold value for monitoring the input voltage. If the input voltage Vin proportionally drops below a threshold, the output of the comparator 903 would be driven high. The high output of the comparator 903 may activate the transistor 906. Responsive to being turned on, the transistor would enable a current flow through an opto-coupler 905, which would cause the output voltage Vout to be driven low. The opto-coupler 905 may provide electrical isolation between the input voltage Vin node and the output voltage Vout node. The electrical isolation may provide appropriate safety between the Vin node and the output voltage Vout node.

While the forgoing has been described in connection with the embodiments of the various figures, it is not limited thereto and it is to be understood that other similar embodiments may be used or modifications and additions may be made to the described embodiments for providing power to an auxiliary device from a secondary device that is connected to a primary device via one or more subscriber lines. Furthermore, it should be emphasized that a variety of computing/processing platforms, including programmable gate arrays, programmable microprocessors, and dedicated hardware are contemplated. Therefore, the present invention should not be limited to any single embodiment, but rather should be construed in breadth and scope in accordance with the appended claims. Also, the appended claims should be construed to include other variants and embodiments of the invention, which may be made by those skilled in the art without departing from the true spirit and scope of the present invention.

What is claimed:

1. A system comprising:
a primary communications device connected to a first end of at least one subscriber line;
a secondary communications device connected to a second end of the at least one subscriber line; and
an auxiliary device connected to the secondary communications device, wherein the auxiliary device is powered by the primary communications device via the at least one subscriber line and the secondary communications device.

2. The system of claim 1, wherein the auxiliary device is in communication with the primary communications device via the subscriber line and the secondary communications device.

3. The system of claim 1, wherein the secondary device is adapted to discontinue powering the auxiliary device based on the power drawn from the at least one subscriber line.

4. The system of claim 1, wherein the auxiliary device is associated with an operating power metric, wherein the subscriber line is associated with a power capacity metric, and wherein the secondary communications device is adapted to enforce a power budget based on the operating power metric and the power capacity metric.

5. The system of claim 4, wherein primary device is adapted to determine the power capacity metric and to send the power capacity metric to the secondary device.

6. The system of claim 4, wherein secondary device is adapted to determine the power capacity metric.

7. The system of claim 1, wherein the secondary communications device comprises a power limiting subsystem to enforce a power budget.

8. The system of claim 7, wherein the power limiting subsystem discontinues power to the auxiliary device to enforce the power budget.

9. The system of claim 7, wherein the power limiting subsystem discontinues power to a subsystem of the secondary communications device to enforce the power budget.

10. The system of claim 1, wherein the secondary device comprises a plurality of subsystems, and wherein the secondary device temporarily disables at least one of the plurality of subsystems to conserve power during a change in state.

11. The system of claim 10, wherein the change in state comprises an initial powering up of the secondary device.

12. The system of claim 1, wherein the auxiliary device is a wireless access point.

13. The system of claim 1, wherein the secondary device is a DSL modem.

14. The system of claim 1, wherein the secondary and auxiliary devices are disposed in the same housing.

15. In a system comprising a first communications device that is adapted to receive power from a subscriber line, and a second communications device that is powered by the subscriber line via the first communications device, a method comprising:
determining a power capacity metric associated with the subscriber line;
determining an operating power metric associated with the secondary communications device;
calculating a power budget for the second communications device from the power capacity metric and the operating power metric; and
enforcing the power budget.

16. The method of claim 15, wherein enforcing the power budget comprises limiting current to the second communications device.

17. The method of claim 15, wherein enforcing the power budget comprises disabling a subsystem of the secondary communications device.

18. The method of claim 17, wherein enforcing the power budget comprises waiting a predetermined duration after disabling the subsystem of the secondary communications device before reenabling the subsystem of the secondary communications device.

19. The method of claim 15, wherein enforcing the power budget comprises disabling the auxiliary device.

20. The method of claim 15, wherein determining the power capacity metric comprises retrieving the power capacity metric from memory.

21. A communications device for providing power to an auxiliary device, the communications device, when connected via a subscriber line to a primary communications device, enables communication between the primary communications device and the auxiliary device, the communications device comprising:
a power input that receives subscriber line power;
a power output that provides power to the auxiliary device; and
a power controller in communication with the power input and the power output that determines a power consumption budget, determines a power consumption metric of the auxiliary device, and limits the power provided by the power input to the power output according to the power consumption budget and the power consumption metric.

22. The device of claim 21, wherein the power controller comprises a controllable switch that provides current to the auxiliary device according to a comparison of a current sense signal with a current reference signal, wherein the current sense signal is indicative of the power consumption metric and wherein the current reference signal is indicative of the power consumption budget.

23. The device of claim 21, wherein the power controller includes a minimum duration during which power consumption metric exceeds the power consumption budget before power to the auxiliary device is limited according to the power consumption budget.

24. The device of claim 21, wherein the secondary device comprises a plurality of subsystems, and wherein the secondary device temporarily disables at least one of the plurality of subsystems to conserve power during a change in state.

25. The device of claim 24, wherein the change of state comprises an initial powering up of the secondary device.

26. The device of claim 21, further comprising a DSL modem in communication with the subscriber line.

27. A communications device for providing power to an auxiliary device, wherein the communications device, when connected via at least one subscriber line to a secondary communications device, provides subscriber line power to the secondary communications device enabling the secondary communications device to power the auxiliary device according to a power consumption budget received from the communications device, the communications device comprising:
a power supply;
a subscriber line interface that powers the at least one subscriber line from power received from the power supply; and
a control unit that determines a power capacity metric related to the at least one subscriber line, determines a power consumption metric of the second communications device, calculates the power consumption budget according to at least the power capacity metric and the power consumption metric of the secondary communications device, and communicates the power consumption budget to the second communications device.

28. The device of claim 27, further comprising a digital subscriber line access multiplexer in communication with the subscriber line.

29. The device of claim 27, wherein the control unit retrieves the power capacity metric from memory.

30. The device of claim 27, wherein the power consumption metric is a function of time.

31. The device of claim 27, wherein the control unit updates the power consumption budget and communicates an updated power consumption budget to the second communications device.
